(19) United States
(12) Patent Application Publication
(10) Pub. No.: US 2005/0034709 A1
(43) Pub. Date: Feb. 17, 2005

(54) Fuel injector and assembly

(76) Inventor: Ulrich Augustin, Blythewood, SC (US)

Correspondence Address: McGuireWoods LLP;Suite 1800, 1750 Tysons Boulevard, Tysons Corner, McLean, VA, 22102-4215, US

(21) Appl. No.: 10/841,511

(22) Filed: May 10, 2004

Related U.S. Application Data
(63) Continuation-in-part of application No. 10/638,322, filed on Aug. 12, 2003.

(51) Int. Cl. F02M 1/00

(52) U.S. Cl. 123/446; 239/89; 239/95; 123/500; 123/494

(57) ABSTRACT

A control valve for an injector includes a spool valve assembly having a spool moveable between an open position and a closed position. The spool has a first hydraulic surface and a second hydraulic surface. A first chamber is in fluid communication with the first hydraulic surface of the spool and a second chamber is in fluid communication with the second hydraulic surface of the spool. An actuator is in fluid communication with the second hydraulic surface of the spool. The actuator, in an open position, provides a fluid path to ambient such that a hydraulic force acting on the first hydraulic surface of the spool becomes greater than a hydraulic force acting on second hydraulic surface of the spool. A flow path is in fluid communication with the second hydraulic surface to decrease a force acting on the second hydraulic surface of the spool during spool operation.

### CROSS REFERENCE TO RELATED APPLICATIONS

This application is a continuation-in-part application of co-pending U.S. patent application Ser. No. 10/638,322, which is hereby incorporated by reference for all purposes as if fully set forth herein.

### BACKGROUND OF THE INVENTION

1. Field of the Invention

The invention generally relates to a fuel injector and, more particularly, to a system for adjusting the sensitivity of the response time of a spool movement in a fuel injector over a wide rang of operating temperatures.

1. Background Description

There are many types of fuel injectors designed to inject fuel into a combustion chamber of an engine. For example, fuel injectors may be mechanically, electrically or hydraulically controlled in order to inject fuel into the combustion chamber of the engine. In the hydraulically actuated systems, a control valve body may be provided with two, three or four way valve systems, each having grooves or orifices which allow fluid communication between working ports, high pressure ports and venting ports of the control valve body of the fuel injector and the inlet area. The working fluid is typically engine oil or other types of suitable hydraulic fluid which is capable of providing a pressure within the fuel injector in order to begin the process of injecting fuel into the combustion chamber.

In current designs, a driver will deliver a current or voltage to an open side of an open coil solenoid. The magnetic force generated in the open coil solenoid will shift a spool into the open position so as to align grooves or orifices (hereinafter referred to as “grooves”) of the control valve body and the spool. The alignment of the grooves permits the working fluid to flow into an intensifier chamber from an inlet portion of the control valve body (via working ports). The high pressure working fluid then acts on an intensifier piston to compress an intensifier spring and hence compress fuel located within a high pressure chamber. As the pressure in the high pressure chamber increases, the fuel pressure will begin to rise above a needle check valve opening pressure. At the prescribed fuel pressure level, the needle check valve will shift against the needle spring and open the injection holes in a nozzle tip. The fuel will then be injected into the combustion chamber of the engine.

However, in such a conventional system, a response time between the injection cycles may be slow thus decreasing the efficiency of the fuel injector. Also, injection events may vary in duration. This is mainly due to the slow movement of the control valve spool. More specifically, the slow movement of the control valve spool may result in a slow activation response time to begin the injection cycle. To remedy this inadequacy, additional pressurized working fluid may be needed; however, additional energy from a high pressure oil pump must be expanded in order to provide this additional working fluid. This leads to inefficiency in the operations of the fuel injector, itself Also, the working fluid at an end of an injection cycle may not be vented at an adequate response rate due to the slow movement of the control valve spool.

A solution to the foregoing problems is the utilization of a piezoelectric actuator system as disclosed in co-pending U.S. patent application Ser. No. 10/638,322. In this system many advantages over the related art systems are provided such as, for example, providing a short control valve stroke. This shorter stroke translates into a fast response time for outflow of the inlet rail pressure, thereby the fuel injector has an increased efficiency over the related art. In this improved system the movement of the control valve stroke, e.g., control spool, is provided by working fluid acting on control surfaces of the spool assembly.

Although the system of co-pending U.S. patent application Ser. No. 10/638,322 provides many advantages over conventional systems, improvements can still be achieved. For example, response times of the spool movement due to the changes in viscosity of the working fluid over a given temperature range may be improved. As should be understood by those of ordinary skill in the art, the viscosity of the working fluid at cooler temperatures is higher than the viscosity of the working fluid at normal temperatures, e.g., 80 to 100 degrees Celsius. Thus, by having a higher viscosity of the working fluid at cold start of the engine, there may be an increase in the flow resistance especially when wall effects are taken into consideration. This may result in slow movement of the control valve spool at higher viscosity levels.

### SUMMARY OF THE INVENTION

In a first aspect of the invention, a control valve for an injector includes a spool valve assembly having a spool moveable between an open position and a closed position. The spool has a first hydraulic surface and a second hydraulic surface. A first chamber is in fluid communication with the first hydraulic surface of the spool and a second chamber is in fluid communication with the second hydraulic surface of the spool. An actuator is in fluid communication with the second hydraulic surface of the spool. The actuator, in an open position, provides a fluid path to ambient such that a hydraulic force acting on the first hydraulic surface of the spool becomes greater than a hydraulic force acting on the second hydraulic surface of the spool. A flow path is in fluid communication with the second hydraulic surface to decrease a force acting on the second hydraulic surface of the spool during spool operation. This may sensitize the system, in one example, over a wide range of operating temperatures.

In another aspect of the invention, a control valve includes a control valve body having an inlet port and a spool valve assembly. The spool valve assembly includes, for example, (i) a spool moveable within a bore between a first position and a second position, (ii) a first control piston having a first diameter positioned at a first end of the spool, (iii) a second control piston having a second diameter positioned at a second end of the spool, (iv) a first control chamber formed by the first control piston and the control valve body, (v) a first fluid connection leading from the inlet to the first control chamber, (vi) a second control chamber formed between a plate and the second control piston, and (vii) a second fluid connection leading from the inlet to the second control chamber. An actuator provides a fluid passage to ambient from the second control chamber, and includes a check plate which is moveable between an open position and a close position seating against a disk. A means is provided for reducing a pressure in the second control chamber during operational conditions of the spool valve assembly.

In yet another aspect of the invention, a fuel injector is provided which includes an intensification chamber, a nozzle assembly, and a control valve assembly. The control valve assembly includes a mechanism in fluid connection with a hydraulic surface of the spool to reduce a working fluid force thereon

### BRIEF DESCRIPTION OF THE DRAWINGS

FIG. 1 shows an oil activated fuel injector used with a piezoelectric control valve of the invention;

FIG. 2 shows an exploded view of an actuator assembly and control valve of the invention;

FIGS. 3a and 3b show an exploded view of an actuator assembly of the invention during operational stages;

FIG. 4a shows a graph of an injector control signal versus time implemented by an aspect of the invention;

FIG. 4b shows a graph of piezo current versus time implemented by an aspect of the invention;

FIG. 4c shows a graph of a spool stroke versus time implemented by an aspect of the invention; and

FIG. 4d shows a graph of injection rate versus time implemented by an aspect of the invention.

### DETAILED DESCRIPTION OF EMBODIMENTS OF THE INVENTION

The invention is directed to, for example, an oil activated fuel injector and more particularly to systems used with an oil activated fuel injector to increase sensitivity of a spool assembly. The control valve of the invention, in one aspect, is designed to increase efficiency of the injector by increasing response times of the spool movement at cold start. That is, the invention addresses, in one aspect, the need to sensitize the entire system to high viscosity conditions of the working fluid at cold start of the engine. In another aspect, the invention sensitizes the system throughout a range of operating conditions. The invention may also be used as a kit to retrofit already existing fuel injectors.

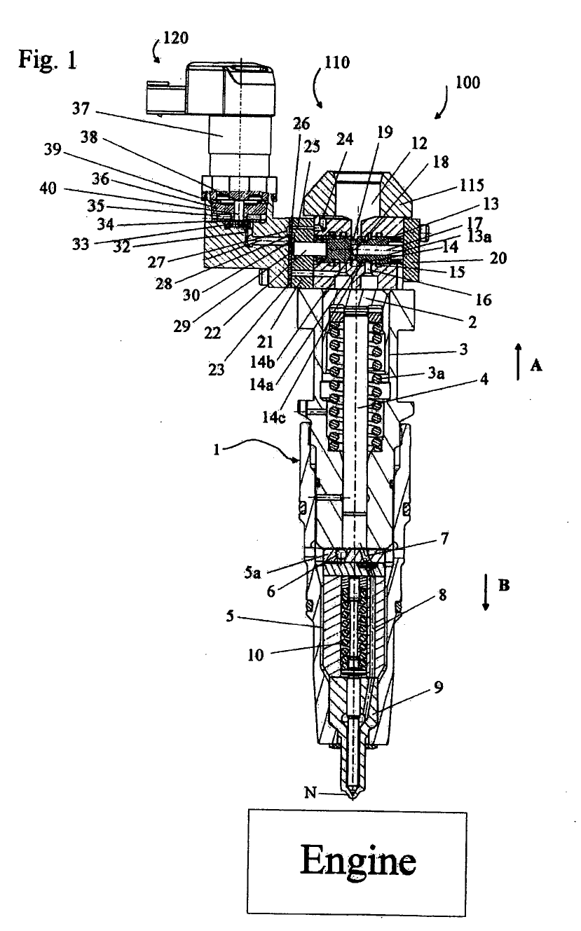

Referring now to FIG. 1, the fuel injector of the invention is generally depicted as reference numeral 100. The fuel injector 100 includes a control valve assembly 110, an actuator assembly 120, and an intensifier body 1 having a piston 2 and plunger 4 disposed within a bore chamber 3. The injector 100 also includes a needle or nozzle assembly 5.

A spring 3a biases the piston 2 and the plunger 4 in a direction of arrow “A”. A high pressure fuel chamber 7 is disposed between the plunger 4 and the nozzle assembly 5, and is in fluid communication with a fuel line 8 leading to a needle assembly 9. A check valve 6 is also provided within the nozzle assembly 5 or alternatively in a disk plate 5a between the nozzle assembly 5 and the intensifier body 1. A spring 10 biases the needle assembly 9 in a direction of arrow “B”.

A valve body is generally depicted as reference numeral 115 and includes an oil or working fluid inlet 12 and a spool 13. The spool 13 includes grooves having control edges depicted generally as reference numeral 14, i.e., a first leading edge 14a and a second leading edge 14b. The valve body 115 also includes grooves, depicted generally as reference numeral 15, which lead to ambient. Working ports 16 are provided in the valve body 115, which lead to the bore chamber 3 and more specifically are in communication with the piston 2. The working ports 16 are also in fluid communication with the working fluid inlet 12 via the grooves of the spool 13 though a space 14c formed between the leading edge 14a and the working port 16 when the spool 13 is in the open position.

A control piston 17 is provided in a center bore 13a of the spool 13. A control volume chamber 18 is formed between the control piston 17 and the spool 13. A cross bore 19 provides fluid communication between the working fluid inlet 12 and the control volume chamber 18. A stop plate 20 is positioned proximate an end portion of the control piston 17, remote from the spool 13. The stop plate 20 provides a mechanism for limiting movement of the control piston 17 during cycles of the fuel injector 100.

A second control piston 22 is provided on another side of the spool, remote from the control piston 17. In one embodiment, the second control piston 22 has a larger surface area than the control piston 17. In one implementation, the second control piston 22 may be upwards of two times the diameter of the control piston 17.

The ratio of size may be 1:1.2 and upwards of 1:2 in one range, and the smaller control piston 17 may be 2.5 mm, but may be 3 mm with the second control piston 22 being 4 mm, in one illustrative implementation. The second control piston 22 is positioned proximate a plate 23 which includes an inlet throttle 26 and an outlet throttle 30.

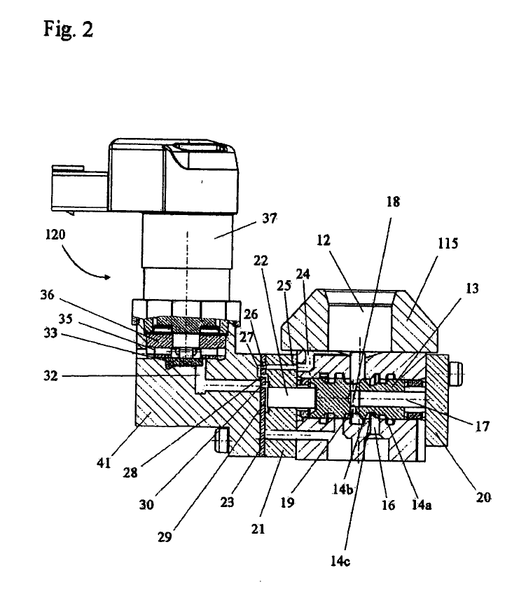

A fluid connection 24 is provided between the working fluid inlet 12 and the inlet throttle 26, via a fluid connection 25 provided in housing 21. In one aspect of the invention, as seen in FIG. 2, the fluid connection 25 has a reduced flow area compared to fluid connection 24 (and that shown in co-pending U.S. patent application Ser. No. 10/638,322) such that the flow path provides an increased flow resistance of working fluid to the hydraulic surface of the control piston 22. The preferred range of dimensions of the fluid connection 25 include a diameter between 0.8 mm to 1.2 mm and a length of between 3 mm to 10 mm. It should be understood, though, that other ranges are also contemplated by the invention, with the caveat that a restriction is provided in one aspect of the invention. Additionally, protrusions or other restriction mechanisms within the fluid path may also be provided by the invention. In conjunction with or separately from the fluid connection 25, the fluid connection 24 can also be restricted to compensate for high viscosity conditions.

By way of one illustrative example, at lower viscosity conditions at normal operating conditions, e.g., with the working fluid at 80 to 100 degrees Celsius, the fluid connection 25 will have no effect on the flow behavior of the working fluid and hence the force asserted against control piston 22. However, at cold start, e.g., temperatures of minus 20 degrees Celsius, the working fluid will have a higher viscosity level thus resulting in increased flow resistance. But, in the configuration of the invention, the reduced flow area or increased flow restriction provided by the fluid connection 25, upstream from the inlet, will reduce the force applied to the control piston 22. That is, the adjustment of the flow connection 25 will allow for faster discharge of the fluid behind the control piston 22 (due, in part, to less fluid buildup in chamber 29). In this manner, the pressure exerted on control piston 22 can be lower than the pressure exerted. against the control piston 17 during an opening operation, thus allowing for a more responsive control valve spool during cold start conditions. Thus, the fluid connection 25 can be used to sensitize the system during cold start.

Referring again to FIG. 1, a fluid connection 27 is provided in a piezo stand or housing 41 between the inlet throttle 26 and a bore 28 provided in either the plate 23 or the housing 21. The bore 28 connects to a control volume chamber 29 of the second control piston 22. In one embodiment, the control volume chamber 29 is formed by the end surface of the second control piston 22, the plate 23 and the housing 21. With the reduced flow area of the fluid connection 25, a reduced amount of flow of working fluid will be provided in the control volume chamber thus affecting the force applied on the control piston 22, e.g., decreasing the force during cold start conditions. An outlet throttle 30 is provided in the plate 23 and provides fluid communication between the control volume chamber 29 and a fluid connection 32 to a check plate 33 in an actuator assembly generally depicted as reference numeral 120. The check plate 33 is seated on a check plate seat 50a about a groove 50.

The actuator assembly includes a housing-like a pot, where the piezo stack is located in the center of the pot. The piezo has substantially the same height as the pot and one end of the piezo is welded on the bottom of the pot. In a final manufacturing process the open side of the pot/piezo assembly is grounded. Once the piezo is activated, the stack expands and comes out of the pot, as discussed in more detail below. In the application of the invention, the center pin makes a relative stroke to the outer part 39 (border of the pot ). Typical strokes of this size of piezo are 20 to 50 microns. In one embodiment, the piezo actuator includes approximately 200 layers of ceramic discs, which respond to a current applied to the piezo actuator 37. It should be well understood, though, that more or less layers and other types of discs are contemplated by the invention and that the example provided herein is for illustrative purposes.

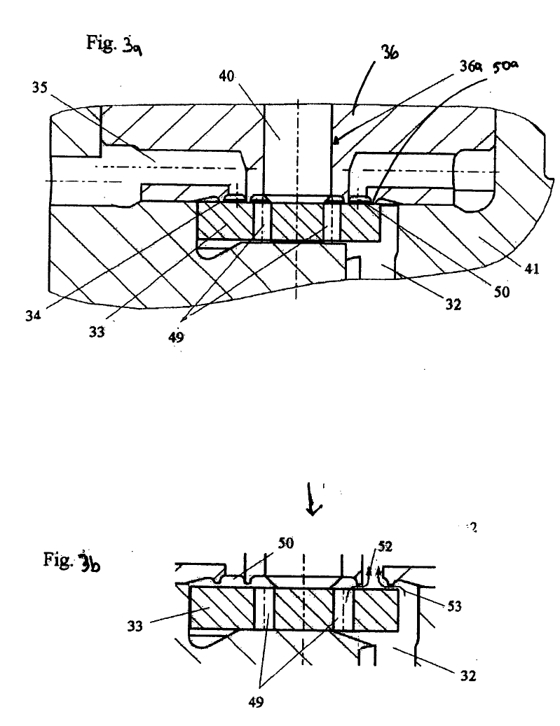

Now referring to FIGS. 2-3a, the actuator assembly 120 includes a fluid connection 35, positioned above the check plate 33, to ambient. A disk 36 having a substantially centrally located bore 36a is positioned between the check plate 33 and the piezo actuator 37. In one aspect of the invention, the disk 36 includes a groove 34 in fluid communication with the fluid connection 35 (outlets to ambient). The piezo actuator 37 further includes a center pin 38 and an outer part 39. A push rod 40 is in mechanical communication with the center pin 38 and is movable via the piezo actuator 37. The push rod 40 is provided within the centrally located bore 36a of the disk 36 and is also in mechanical communication with the check plate 33. Upon activation of the piezo stack, the push rod 40 will move via the expansion of the stack, itself, resulting in the movement of the check plate 33 away from the check plate seat 50a.

In FIG. 3a, the check plate 33 is shown to include a plurality of bores 49 positioned about a center of the check plate 33. In one embodiment, the bores 49 are approximately 1 mm in diameter and are positioned about the outer diameter of the push rod 40, e.g., at an approximate 3 mm diameter. In embodiments, upwards of eight bores 49 may be provided in the check plate 33; however, more or less than eight bores are also contemplated for use by the invention depending on the required flow properties of the working fluid flowing to ambient. Also, other means within the check plate such as, for example, other fluid communicating structures are also contemplated by the invention. These other structures may be cutouts, mortises, edge cutouts, or the like.

In FIG. 3b, upon application of the piezo stack stroke, the bores 49 are in fluid communicate with the groove 50 and hence the passage 35 in order to increase the flow rate of the working fluid to ambient. For example, as shown in FIG. 3b, the piezo stack stroke will move the push rod 40 which, in turn, will unseat the check plate 33 from the check plate seat 50a. Upon this occurrence, the working fluid is capable of flowing past the groove 34 via flow path 53 to ambient, in addition to the working fluid flowing through bore 49 to ambient via fluid path 52. The flow path 53 may include the groove 34 which will increase the flow rate of the working fluid, e.g., decrease flow resistance of working fluid to ambient when the actuator is in the open position, when the check plate is unseated from the disk. The groove may be a circular in shape or other geometry positioned about an edge of the check plate, which is seated on the disk when the actuator is in a closed position. In this configuration, the expanded flow path will increase a flow rate of the working fluid which, in turn, will lower the pressure within the chamber 29 and increase the discharge of the working fluid, in both cold and normal operating conditions. This will occur for every bore provided in the check plate, for example.

It should be understood that before the piezo opens the check plate 33, its low pressure side is pressurized from the center to an inner seat 51, which reduces the force requirement of the piezo. The required piezo force is dependent on the area of groove 50, the fluid pressure and the diameter of rod 40. In the configuration of FIG. 3a, for example, the fluid flows from the center and from outside via the flow paths 52 and 53 which approximately doubles the flow area from a conventional system.

Much like the discussion with reference to the restricted fluid connection 25, this dual passage configuration will reduce the pressure on the control piston 22 during cold start conditions. But, in addition, this dual passage configuration also has the advantage of increasing the flow rate of the working fluid during normal operating conditions and thus allows for more responsiveness of the spool movement over a wide range of temperatures. In one embodiment, for high viscosity conditions, the modified check plate 33 and disk 36 may be designed to have a same flow reduction as that of the modified fluid connection at the inlet side of the spool valve assembly, as discussed above.

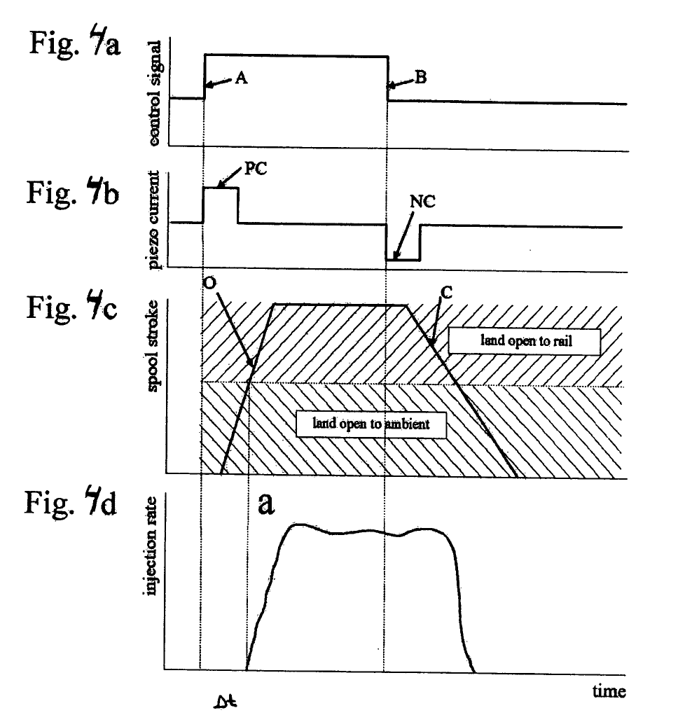

FIGS. 4a-4d show graphs of the injector control signal, the piezo current, the spool stroke and the injection rate versus time, respectively. More specifically, FIG. 4a shows a control signal that is provided to the driver of the piezo actuator 37. The first leading edge “A” of the control signal will trigger the positive driver current “PC” of the piezo actuator, as shown in FIG. 4b. At this time, the piezo actuator 37 will lengthen to open the spool valve assembly, as discussed above. The control signal will be responsible for the duration of the activation of the piezo actuator. In one embodiment, the control signal may last between 200 and 5000 microseconds, depending on the desired fuel quantity. It is also contemplated that the control signal may last for a longer or shorter time period, in certain applications.

Still referring to FIGS. 4a and 4b, the negative driver current “NC” (FIG. 4b) is triggered by the falling edge “B” of the control signal of FIG. 4a. At this time, the spool valve assembly will begin to close; that is, the spool valve assembly will remain open until a reverse current is applied to the driver of the piezo actuator. In one embodiment, the pulses or currents may be approximately 100 microseconds in duration. As should now be understood, there is slight delay between the application of the positive driver current “PC” and the negative driver current “NC” and the thus opening and closing of the spool valve assembly. For example, the delay, in one embodiment, may be about 100 microseconds or less. This delay may vary between injectors and/or over a specific injector's lifetime.

In one embodiment, the positive driver current “PC” of the piezo actuator is +10 amps and the negative driver current “NC” is −10 amps. A corresponding voltage of 150V and 0V may be applied. It should be understood by those of ordinary skill in the art that different amperages may be used depending on the specific application of the invention. For example, additional layers utilized in the piezo actuator may translate into the need for a bigger current and a smaller voltage.

Likewise, fewer layers used with the piezo actuator may translate into the need for a smaller current and a bigger voltage. However, in one implementation, a current of +/−10 amps is used with approximately 200 layers of the piezo actuator.

FIGS. 4c and 4d show the relationship between the spool stroke and the injection rate of the fuel injector. Referring to FIG. 4c, the bottom portion of the graph, i.e., land open to ambient, represents the spool valve assembly in the closed position; whereas, the upper portion of the graph, i.e., land open to rail, represents the spool valve assembly in the open position or a flow connection between the working fluid inlet 12 and the intensifier piston 2. It should be understood by those of ordinary skill in the art, though, that delay times Δt may exist; that is, the spool valve assembly may remain open for a short period of time in the bottom portion of the graph after the negative driver current or pulse is applied as shown in FIG. 4c. Also, the spool valve assembly may remain closed for a short period of time in the top portion of the graph after the positive driver current or pulse is applied as shown in FIG. 4c. But the system of the invention, affecting the force applied to the spool by working fluid, addresses delay times over a wide range of operating conditions.

Referring back to FIG. 4c with reference to FIGS. 4a and 4b, after the positive driver current “PC” is applied, the spool valve assembly begins to open at a substantially constant speed as represented by the linear line “O”. At the peak of the graph of FIG. 4c, the spool motion is stopped until the negative driver current “NC” is applied, at which time the spool valve assembly begins to close at a substantially constant speed. By using the invention, delay times may be significantly reduced due to the adjusted flow rates provided by in the inflow or outflow of the working fluid upstream or downstream, respectively, from the control volume chamber 29.

### Method of Use

In operation, the check plate 33 and the spool valve assembly are movable between a closed position and an open position via application of the positive and negative driver current applied to the piezo actuator 37. That is, the current applied to the piezo actuator 37 is used to lengthen and shorten the piezo actuator 37, i.e., ceramic discs of the piezo actuator 37, to open and close the check plate 33 to ambient via the center pin and push rod assembly. In the open position, fluid in the control volume chamber 29 is vented to ambient via paths 52 and 53, and the pressure within the control volume chamber 18 is greater than that of the control volume chamber 29. The hydraulic forces acting on the control piston 17, being greater than the hydraulic forces acting on the second control piston 22, will then move the spool valve assembly to the open position. In this operational stage, the flow of the working fluid is considerably increased by flowing to ambient via two directions, 52 and 53. Flow restriction via the fluid connection 25 may also result in a decrease pressure in the control volume chamber 29 (resulting in a decrease in force acting on the control piston 22) thus increasing the sensitivity of the system.

When the negative driver current is applied, the check plate 33 will block ambient and the hydraulic forces acting on the second control piston 22 will increase and become greater than the hydraulic forces acting on the control piston 17 such that the spool valve assembly will be moved into the closed position. At this operational stage, due to the restricted flow passage of flow connection 25, the pressure within the control volume or chamber 29 will not be as high during cold start compared to normal operations. This is mainly due to the combination of the restricted flow path and the higher viscosity of the working fluid. During normal conditions, the restricted flow path will not affect the flow rate of the working fluid.

While the invention has been described in terms of embodiments, those skilled in the art will recognize that the invention can be practiced with modification within the spirit and scope of the appended claims.

1. A control for an injector, comprising:
a spool valve assembly having a spool moveable between an open position and a closed position, the spool having a first hydraulic surface and a second hydraulic surface;
a first chamber in fluid communication with the first hydraulic surface of the spool;
a second chamber in fluid communication with the second hydraulic surface of the spool;
an actuator assembly in fluid communication with the second hydraulic surface of the spool, the actuator assembly, in an open position, provides a fluid path to ambient such that a hydraulic force acting on the first hydraulic surface of the spool becomes greater than a hydraulic force acting on the second hydraulic surface of the spool; and
a flow path in fluid communication with the second hydraulic surface to decrease a force acting on the second hydraulic surface of the spool during spool operation.

2. The control of claim 1, wherein the flow path is either upstream or downstream from the second hydraulic surface.

3. The control of claim 1, wherein the flow path includes an actuator check plate of the actuator assembly having at least one bore leading to ambient when the actuator assembly is in the open position.

4. The control of claim 3, wherein the at least one bore is two or more bores provided about a central location of the actuator check plate.

5. The control of claim 3, wherein the at least one bore increases a flow rate of working fluid to ambient when the actuator is in the open position.

6. The control of claim 1, wherein the flow path provides a dual fluid passage for working fluid to pass to ambient when the check place is unseated.

7. The control of claim 6, wherein the dual fluid passage includes a fluid passage between a bore of an actuator check plate leading to ambient and an edge pathway along the actuator check plate leading to ambient.

8. The control of claim 7, wherein the edge pathway includes a groove provided in a disk of the actuator assembly, the disk acts as a seat for the actuator check plate when the actuator assembly is in a closed position.

9. The control of claim 1, wherein the fluid path is an expanded fluid passageway associated with the actuator assembly leading to ambient.

10. The control of claim 1, wherein the fluid path is an expanded fluid passageway associated with the actuator assembly leading to ambient and a restricted fluid pathway leading to the second hydraulic surface upstream therefrom.

11. The control of claim 9, wherein the expanded fluid passageway includes a shaped groove formed in a disk of the actuator assembly proximate a side edge of an actuator check plate which is seated on the disk when the actuator assembly is in a closed position.

12. The control of claim 1, wherein the flow path decreases a flow rate of working fluid during cold conditions and maintains a steady flow rate of the working during other conditions, leading to the second hydraulic surface.

13. The control of claim 12, wherein the flow path includes a fluid channel upstream from the second hydraulic surface and has a first diameter greater than a second diameter.

14. The control of claim 1, wherein the flow path provides a decreased flow resistance of working fluid to ambient when the actuator assembly is in the open position.

15. The control of claim 1, further comprising:
a first volume chamber formed partly by the first hydraulic surface of the spool;
a second volume chamber formed partly by the second hydraulic surface of the spool,
wherein the flow path decreases the pressure within the second volume chamber by increasing a flow rate of working fluid when the actuator assembly is open or increases flow resistance upstream from the second volume chamber during cold start conditions.

16. The control of claim 15, further comprising an inlet throttle leading to the second hydraulic surface and an outlet throttle leading to the actuator assembly from the second hydraulic surface, the inlet and outlet throttle being disposed in a plate between an actuator assembly housing the actuator and a spool valve assembly housing the spool.

17. The control of claim 1, wherein the actuator assembly includes a check plate, a center pin and a push rod in mechanical communication with the center pin, wherein a bore of the check plate acts as the flow path and leads to ambient to increase a flow rate of working fluid when the actuator is open and decreases a force applied on the second hydraulic surface.

18. A control valve, comprising:
a control valve body having an inlet port and a bore;
a spool valve assembly having a spool moveable within the bore between a first position and a second position, the spool valve assembly further including:
a first control piston having a first diameter positioned at a first end of the spool, a first control chamber formed by the first control piston and the control valve body, and a first fluid connection leading from the inlet to the first control chamber; and
a second control piston having a second diameter positioned at a second end of the spool, a second control chamber formed between a plate and the second control piston, and a second fluid connection leading from the inlet to the second control chamber;
an actuator providing a fluid passage to ambient from the second control chamber, the actuator including a check plate which is moveable between an open position and a closed position seating against a disk, the check plate being in fluid communication with the fluid passage; and
a means for reducing a pressure in the second control chamber during operational conditions of the spool.

19. The control valve of claim 18, wherein the reducing means includes a groove provided in the disk about an edge of the check plate, the groove providing an increased flow passage to ambient when the check plate is unseated.

20. The control valve of claim 19, wherein the reducing means further includes at least one bore in the check plate leading to the fluid passage to ambient.

21. The control valve of claim 18, wherein the reducing means includes a restricted portion of the second fluid connection.

22. The control valve of claim 18, wherein the reducing means is at least one of upstream and downstream from the second fluid connection.

23. The control valve of claim 21, wherein the second fluid connection includes two different diameter sections leading from the inlet to the second control chamber.

24. The control valve of claim 18, wherein the reducing means reduces a flow rate of working fluid entering into the second control chamber only during cold start.

25. The control valve of claim 18, wherein the reducing means includes:
a groove provided in the disk about an edge of the check plate;
at least one bore in the check plate leading to the fluid passage to provide a dual passage with the groove when the check plate is unseated from the disk; and
a restricted flow path portion of the second fluid connection leading to the second control chamber.

26. A fuel injector, comprising:
an intensification body including a bore having a plunger and piston assembly biased in a first direction by a first spring and an intensifier chamber for pressurizing fuel;
a nozzle assembly in communication with the intensification body, the nozzle assembly including a needle valve system biased by a second spring to block injection ports and including a hydraulic surface to raise the needle valve away from the injection ports during an injection event; and
a control valve assembly in communication with the intensification body, the control valve assembly including a control valve body having a bore and a plurality of fluid connections, a spool valve assembly moveable within the bore and having a first hydraulic surface and a second hydraulic surface in fluid communication with a first fluid connection and a second fluid connection, respectively, an actuator having a check plate and a seating disk, the check plate and the seating disk at least partially in fluid connection with the second hydraulic surface of the spool valve and ambient, and a mechanism in fluid connection with the second hydraulic surface to reduce a working fluid force thereon.

27. The fuel injector of claim 26, wherein the mechanism includes at least one bore in the check plate and a groove formed about the disk.

28. The fuel injector of claim 27, wherein the mechanism further includes a restricted flow path within the second fluid connection.

29. The fuel injector of claim 26, wherein the mechanism includes at least one bore in the check plate.

30. The fuel injector of claim 26, wherein the mechanism includes a restricted flow path within the second fluid connection upstream from the second hydraulic surface.
